(19) United States
(12) Patent Application Publication
(10) Pub. No.: US 2016/0266340 A1
(43) Pub. Date: Sep. 15, 2016

(54) LATCHING AND EMI SHIELDING MECHANISM FOR AN OPTICAL MODULE

(71) Applicant: FINISAR CORPORATION, Sunnyvale, CA (US)

(72) Inventors: RANRAN ZHANG, Sunnyvale, CA (US); SHAMEI SHI, Sunnyvale, CA (US); WILLIAM H. WANG, Sunnyvale, CA (US)

(21) Appl. No.: 14/643,933

(22) Filed: Mar. 10, 2015

(51) Int. Cl. G02B 6/42; G02B 6/38; G02B 6/32

(52) U.S. Cl. CPC G02B 6/4292; G02B 6/4206; G02B 6/32; G02B 6/3893; G02B 6/3887; G02B 6/4277; G02B 6/3895

(57) ABSTRACT

An example embodiment includes a pluggable active optical cable product configured to maintain engagement of an optical interface included in an optoelectronic module. The pluggable active optical cable product includes a lens connection section which connects a plurality of optical fibers to the optical interface, a clip configured to surround the lens connection section and the optical interface so as to apply a compressive force which urges the lens connection section to connect to the optical interface, an bottom shell which houses the lens connection section, optical interface, and clip, and an upper shell which is configured to be disposed on a surface of the bottom shell when assembled with the bottom shell so as to form an enclosure for the lens connection section, the optical interface, and the clip.

### CROSS-REFERENCE TO RELATED APPLICATIONS

None.

### FIELD

Embodiments disclosed herein relate to optical components. In particular, some embodiments described herein relate to a latching and electromagnetic interference (EMI) shielding mechanism which may be used with optoelectronic modules.

### BACKGROUND

Fiber-optic transmission media are increasingly used for transmitting optical, voice, and data signals. As a transmission vehicle, light provides a number of advantages over traditional electrical communication techniques. For example, optical signals enable extremely high transmission rates and very high bandwidth capabilities. Also, optical signals are unaffected by electromagnetic radiation that causes electromagnetic interference (“EMI”) in electrical signals. Optical signals also provide a more secure signal because the optical transmission medium, such as an optical fiber, does not allow portions of the signal to escape, or be tapped, from the optical fiber, as can occur with electrical signals in wire-based transmission systems. Optical signals can also be transmitted over relatively greater distances without experiencing the signal loss typically associated with transmission of electrical signals over such distances.

While optical communications provide a number of advantages, the use of light as a data transmission vehicle presents a number of implementation challenges. For example, prior to being received and/or processed, the data represented by the optical signal must be converted to an electrical form. Similarly, the data signal must be converted from an electronic form to an optical form prior to transmission onto the optical network.

These conversion processes may be implemented by optical transceiver modules located at either end of an optical fiber. A typical optical transceiver module contains a laser transmitter circuit capable of converting electrical signals to optical signals, and an optical receiver capable of converting received optical signals into electrical signals. The optical transceiver module may be electrically interfaced with a host device, such as a host computer, switching hub, network router, switch box, or computer I/O, via a compatible connection port.

One example of a connection port and compatible connector that is currently used in the art is a plug-and-play multi-fiber push-on (MPO) receptacle, which enables a multi-fiber cable, such as a 12-fiber cable including Quad (4-channel) Small Form-factor Pluggable (QSFP), CXP, CDFP, CFP2, and CFP4 active optical cables, to connect to the optical network and accelerate bandwidth and traffic speeds. Currently, such systems are used to support multiple-dwelling unit (MDU) applications and core network applications, including central offices, switching centers, data centers, radio network controllers, base station controllers and cell sites.

Pluggable optoelectronic devices are increasingly used in connection with fiber optic communication equipment electronic equipment. For example, pluggable electronic or optoelectronic transceiver modules, are increasingly used with host networking equipment for electronic and optoelectronic communication. Pluggable electronic or optoelectronic modules typically communicate with a printed circuit board of a host device by transmitting electrical signals to the printed circuit board and receiving electrical signals from the printed circuit board. These electrical signals can then be transmitted by the pluggable electronic module outside the host device as electrical or optical signals. Multi-source agreements (MSAs) specify, among other things, body dimensions for pluggable electronic modules. Conformity with an MSA allows a pluggable electronic or optoelectronic module to be plugged into host equipment designed in compliance with the MSA.

One common difficulty associated with pluggable electronic or optoelectronic modules concerns the retention of the modules within corresponding host devices and the retention of electrical or optical cables within corresponding electronic or optoelectronic modules. Although various mechanisms have been developed in order to facilitate secure and precise retention of pluggable electronic or optoelectronic modules within host devices and precision retention of electrical or optical cables within electronic or optoelectronic modules, these mechanisms can be problematic in certain applications. In particular, these imprecise retention mechanisms can lead to imprecise electrical or optical connections between a printed circuit board of a pluggable electronic or optoelectronic module and a printed circuit board of a host device or between an electrical or optical cable and a pluggable electronic or optoelectronic module.

For example, many pluggable electronic or optoelectronic module retention mechanisms introduce so called “backlash” into the positioning of the module within the host device and into the positioning of the cable within the module. “Backlash” refers to an inadvertent repositioning of a pluggable electronic or optoelectronic module within the host device or an inadvertent repositioning of an electrical or optical cable within an electronic or optoelectronic module due to the operation of the retention mechanism. This “backlash” generally degrades the precision of the electrical connections between the module printed circuit board and the host printed circuit board and degrades the precision of the electrical or optical connections between the cable and the module. Further, many host devices are configured to abut the pluggable electronic or optoelectronic module against an uncontrolled feature within the host device, which can also degrade the precision of the electrical connections between the module printed circuit board and the host printed circuit board. This “backlash” and uncontrolled feature abutment contribute to imprecise alignment of electrical connections between the pluggable electronic module and host device, which can result in unacceptable signal loss at these electrical connections.

Hence, one difficulty with the existing active optical cable products is that while they have generally been designed to be easily plugged in and out of the corresponding receptacle, it is difficult to create a stable optical interface which isolates external force and prevents it from dislocating or interfering with the optical interface. Furthermore, it may be difficult to provide a simple and compact system and configuration which provides a secure mechanical connection which secures the cables to the transceiver modules and to provide an optimal interface between the cable ferrule and the transceiver lens. Without the ability to securely attach and connect the cables, it is difficult to provide products where the transceiver module and active optical cable products are able to operate effectively and efficiently.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY

An example embodiment includes a pluggable active optical cable product configured to maintain engagement of an optical interface included in an optoelectronic module. The pluggable active optical cable product includes a lens connection section which connects a plurality of optical fibers to the optical interface, a clip configured to surround the lens connection section and the optical interface so as to apply a compressive force which urges the lens connection section to connect to the optical interface, an bottom shell which houses the lens connection section, optical interface, and clip, and an upper shell which is configured to be disposed on a surface of the bottom shell when assembled with the bottom shell so as to form an enclosure for the lens connection section, the optical interface, and the clip.

Another example embodiment includes an integrated active optical cable and optoelectronic module. The integrated cable and optoelectronic module includes an optical interface an optical interface which interfaces with a port of a host device, a lens connection section which connects a plurality of optic fibers to the optical interface, a clip configured to surround the lens connection section and the optical interface so as to apply a compressive force which urges the lens connection section to connect to the optical interface, an bottom shell which houses the lens connection section, optical interface, and clip, an upper shell which is configured to be disposed on a surface of the bottom shell when assembled with the bottom shell so as to form an enclosure for the lens connection section, the optical interface, and the clip, and a latching mechanism configured to rotate about an axis between a latched position and an unlatched position, the latching mechanism comprising a pair of follower arms which engage with the host device when the latching mechanism is in latched position and disengages with the host device when the latching mechanism is in the unlatched position.

As may be understood by one of art, the embodiments described herein provide a more reliable active optical cable by providing a simple mechanical structure which secures the ribbon fiber of the active optical cable so as to provide a more reliable connection between the ribbon fiber and an optoelectronic module. In some instances, the embodiments are also capable of containing electromagnetic interference leakage from escaping the active optical cable. Other embodiments may include a latching mechanism that provides improved retraction, reduces friction between the latching mechanism and other components of the active optical cable, and which reduces the overall height of the active optical cable product.

The object and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIGS. 1A-1B are isometric views of an active optical cable which is an example of a latching and shielding mechanism of a first embodiment of the invention;

FIG. 2 is an exploded isometric view of the active optical cable of the first embodiment shown in FIGS. 1A-1B;

FIGS. 3A-3B are isometric views shown in the latched and unlatched positions of the active optical cable of the first embodiment;

FIG. 4 is a cross-sectional view illustrating how light is transmitted through the lens of the optical transceiver module into the fibers of the active optical cable of the first embodiment;

FIG. 5 is an isometric view of the active optical cable of the first embodiment shown with the top shell and latch not being shown;

FIG. 6 is a isometric view of the clip which is used in association with the first embodiment;

FIG. 7 is a top view of a cross-section of the active optical cable of the first embodiment;

FIG. 8 is an isometric exploded view showing the active optical cable of the first embodiment;

FIG. 9 is an isometric cross-sectional view showing the EMI gasket and EMI paste position of the first embodiment;

FIG. 10 is an isometric cross-sectional view showing the top shell of the active optical cable according to the first embodiment which accommodates the EMI paste, EMI gasket, and EMI tape;

FIG. 11 is a cross-sectional view showing the EMI paste and EMI gasket inside the slots of the top and bottom shell of the active optical cable according to a first embodiment of the invention; and

FIG. 12 is a cross-sectional view showing the EMI paste and EMI gasket inside the slots of the top and bottom shell of the active optical cable according to a first embodiment of the invention.

### DESCRIPTION OF SOME EXAMPLE EMBODIMENTS

Particular embodiments of the present disclosure will be described with reference to the accompanying drawings. The illustrative embodiments described in the detailed description, drawings, and claims are not meant to be limiting. Other embodiments may be utilized, and other changes may be made, without departing from the spirit or scope of the subject matter presented herein. The aspects of the present disclosure, as generally described herein, and illustrated in the Figures, can be arranged, substituted, combined, separated, and designed in a wide variety of configurations, all of which are explicitly contemplated herein.

Embodiments disclosed herein relate to optical components. More particularly, some example embodiments relate to a cable connector for an optoelectronic module, cable latching mechanism, and cable retention design, which isolates any external force from the optoelectronic module and ensures that the connection between the ferrule and lens is secure. The embodiments described herein also provide various benefits including the ability to simplify manufacturing processes by simplifying assembly and the ability to rework components. Further, embodiments herein are capable of being implemented without modifying the overall size and structure of existing products.

An example embodiment includes a cable connector that may be plugged into an optoelectronic module so as to maintain engagement of the multi-fiber cable to an optical engine. In instances where the cable connector is used on both ends of a multi-lane fiber optical cable, an active optical cable product may be provided that has a transceiver module securely attached to each end of the optical cable.

Although the embodiments are described in the context of optical transceiver modules and active optic cables used in the field of optical networking, it will be appreciated that embodiments of the invention may be employed in other fields and/or operating environments where the functionality disclosed herein may be useful. Accordingly, the scope of the invention should not be construed to be limited to the exemplary implementations and operating environments disclosed herein.

Embodiments of the present disclosure will now be explained with reference to the accompanying figures.

I. Exemplary Aspects of Existing Active Optical Cables

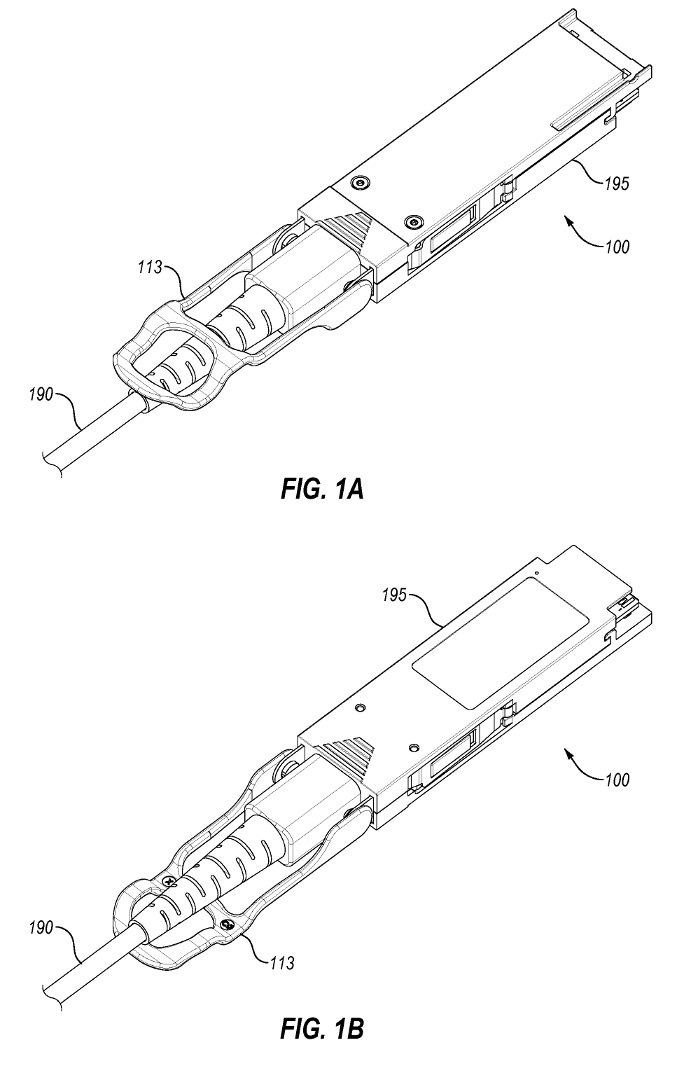

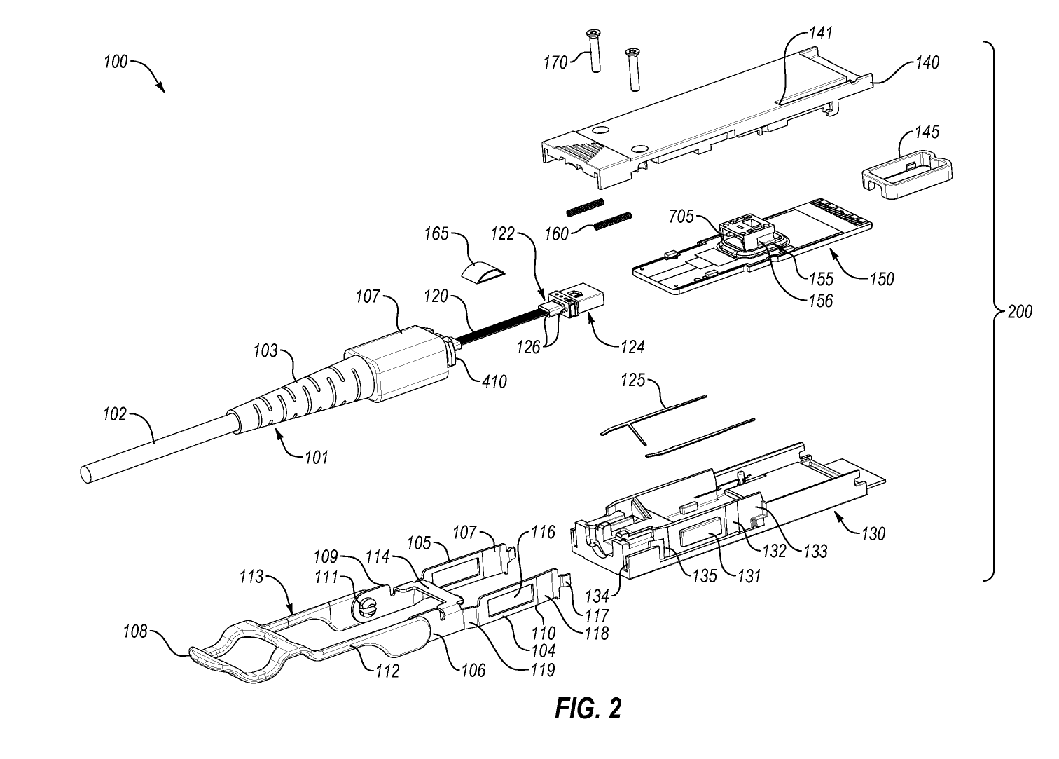

FIGS. 1A-1B are isometric views of an QSFP active optical cable product 100 which includes an QSFP active optical cable 190 with an integrated QSFP transceiver module, which is an example of an optoelectronic module 195. In this example, the optoelectronic module 195 is hot-pluggable, or is designed to be plugged into a larger electronic system such as a printed circuit board (PCB) of a host device or the like. A handle or bailing mechanism 112 of the active optical product 100 enables the active optical product 100 to be connected and removed from the larger electronic system so as to connect and disconnect the optoelectronic module 195 from the larger electronic system. One difficulty with the handle or bailing mechanism 112 of the active optical product 100, however, is that the latching and disconnecting force applied to the driver 112 may result in the active optical cable 100 being jostled and the transfer of the external force to the internal components of the active optical product 100 via the ribbon fiber 120 (shown in FIG. 2) contained in the active optical cable 100. Similarly, any other forces applied to the active optical cable product 100 may result in the transfer of external force to the internal components of the active optical product 100.

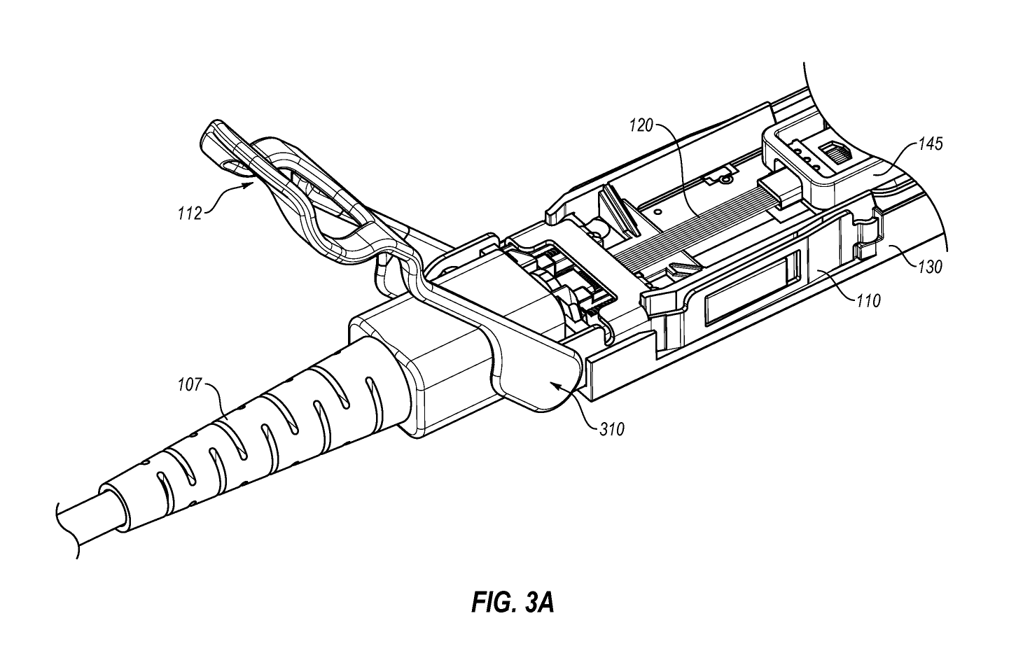

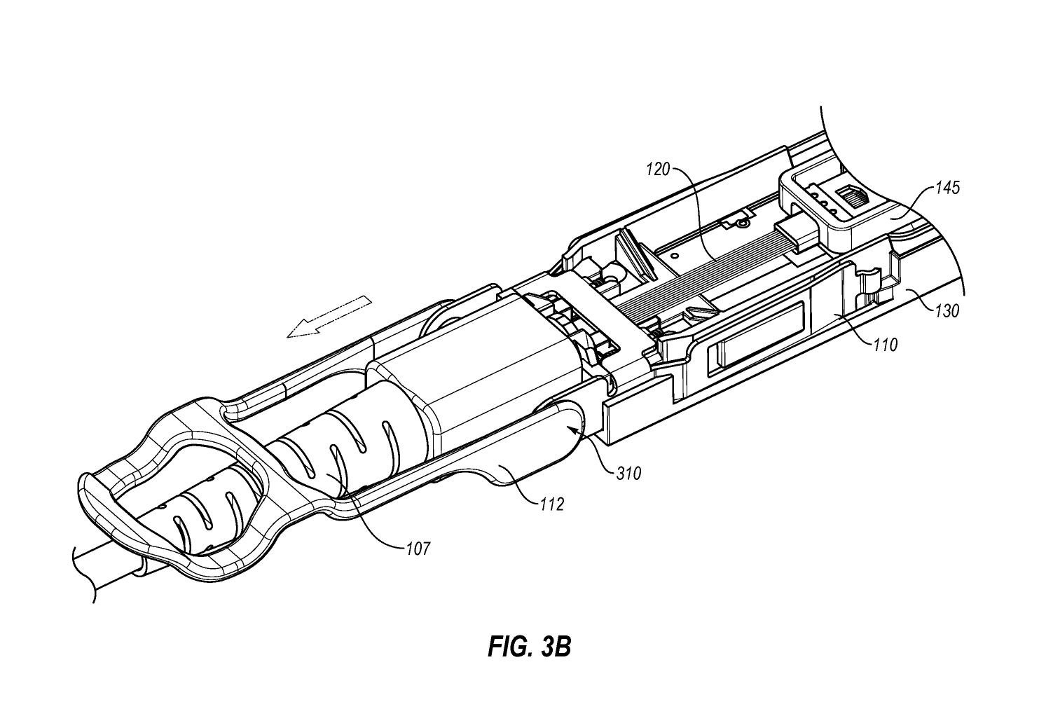

Embodiments described herein provide a mechanism for preventing the transfer of the external force to the internal components of the active optical product 100. As is described more fully below with respect to FIGS. 3-4, the benefit of embodiments described herein is that the lens alignment between a lens and a printed circuit board of the optoelectronic module 195 may be ensured. Furthermore, embodiments herein provide EMI shielding so as prevent EMI leakage from the internal components of the optoelectronic module 195.

II. Exemplary Structural Aspects of an Active Optical Cable Product

Reference is first made to FIGS. 1A-1B and 2, which illustrate an example of an active optical cable product 100 according to one embodiment. As was previously described, FIGS. 1A-1B are isometric views of the active optical cable product 100, while FIG. 2 is an exploded isometric view of the active optical cable product 100 of FIGS. 1A-1B.

The optoelectronic module product 100 depicted in FIGS. 1A-1B and 2 include an optoelectronic module 195. An example of the optoelectronic module 195 may be designed for high-speed (e.g., 25 gigabits per second (Gbps) or higher) optical interconnects between integrated circuits and/or between circuit boards. Additionally or alternatively, the optoelectronic module 195 may be configured to receive twelve, twenty-four, or other quantity of optical channels, each of which may be configured to communicate data.

Once mounted to a host PCB (not shown), the optoelectronic module 200 may be configured to communicate data between the host device and a network (not shown), for example. The optoelectronic module 200 may convert electrical signals to optical signals representing the electrical signals and vice versa. For example, data in the form of optical signals may be communicated from a network along the active optical cable 190 to the optoelectronic module 195. Components (examples of which are described below) of the optoelectronic module 195 may convert the optical signals to electrical signals representative of the optical signals. The electrical signals may then be communicated to the host device. Likewise, the host device may communicate electrical signals to the optoelectronic module 195. The optoelectronic module 195 may convert the electrical signals to optical signals representative of the electrical signals. The optical signals may be communicated along the active optical cable 190 into the network to, e.g., another optoelectronic module 195.

The active optical cable portion 190 of the active optical cable product 100 includes a MT ferrule 124, a ferrule boot 122. The ferrule boot 122 connects to a plurality of optical ribbon fibers 120 which extend to a cable boot 107 which comprises a transition portion 103 which is connected to protective tube 102 which encloses the optical ribbon fibers 120.

As may be understood by one skill in the art, the optical ribbon fibers 120 may be individually coated with plastic layers within the protective tube 102 and within the various other components of the active optical cable portion 190 including the cable boot 107, MT ferrule boot 122, MT ferrule 124. Further, the plastic layers and the protective tube 102 are made of materials which are suitable for the environment where the active optical cable product 100 will be deployed and the embodiments described herein are not limited to any particular materials.

FIG. 2 also illustrates the latching mechanism 113 of the present embodiment. Generally speaking, the latching mechanism 113 includes a driver 112 and a follower 109 and a pair of springs 160 housed in an assembled body 200 consisting of a bottom shell 130 and a top shell 140. The driver 112 and follower 109 may be formed in various ways using a variety of materials including metal or molded plastic. The springs 160 are shown as coiled springs, but the springs 160 may also be replaced with torsional or wire springs, for example.

The driver 112 is configured to rotatably attach to the follower 109 by pushing the protrusions 111 of the driver 112 into the holes of the follower 109 between a latched and unlatched position as is shown in FIGS. 3A and 3B. More specifically, as is shown in FIG. 3A, a user can pull on a pull tab portion 108 of the driver 112 when the follower 109 is in the latched position in order to move the follower 109 connected to the driver 112 via the rotational axis 310 in the direction shown by the arrow into the unlatched position (shown 3B).

The follower 109 is configured to slidably attach to an assembled body 200 comprising a top shell 140, bottom shell 130, printed circuit board assembly (PCBA) 150, lens 155, clip 145, and active optical cable portion 190. Various aspects of the assembled body 200 will be described more fully below.

As disclosed in FIG. 2, the follower 109 includes a pair of follower arms 104 and 105 which are connected via a cross portion 114. The follower arms 104 and 105 include ramps 117 facing away from the driver 112. The follower arms 104 and 105 also define indentations 110 that are configured to slidably engage with the corresponding mounds 131 of the bottom shell 130 of the assembled body 200. More particularly, the indentations 110 each include a rectangular window 116 which is configured to house the corresponding mounds 131 of the bottom shell 130 of the assembled body 200. As is clearly shown in FIGS. 3A and 3B, the rectangular window 116 is configured so as to have a larger area in the cable insertion/removal direction so as to enable the corresponding mounts 131 of the bottom shell 130 of the assembled body 200 to slidably couple the follower 109 to the assembled body 200. During assembly, the follower arms 104 and 105 of the follower 109 can be bent outward in order to initially slide the follower arms 104 and 105 over the mounds 131 of the bottom shell 180 and then released so that the mounds 131 are positioned within the rectangular windows 116 of each of the follower arms 104 and 105, respectively.

The follower arms 104 and 105 also each include recessed flat portion 118 which is housed in a flat recessed portion 132 of the bottom shell 130 after assembly. The follower arms 104 and 105 also include a ramped shoulder portion 119 and a flat neck portion 106 which are formed so as to correspond to a ramped portion 135 of the bottom shell 130 and a flat slot 134 of the bottom shell 130 which helps apply an urging force which urges the follower arms 104 and 105 towards the corresponding outer surfaces of the bottom shell 130.

As is shown in FIGS. 3A and 3B, when the pull tab 108 is pivoted and pulled in the axial direction, axial sliding of the follower 109 along the assembled body 200 is enabled. The biasing force created by the springs 160 disclosed in FIG. 1 is overcome.

Although the example latching mechanism 113 is employed herein in connection with the example host device (not shown) and the example optoelectronic module 195, it is understood that the example latching mechanism 113 could instead be employed in connection with other electronic devices and host equipment.

During the insertion of the optoelectronic module product 100 into a host cage of a host device, the driver 112 of the latching mechanism 113 may initially be in the unlatched position, as shown in FIG. 3B. A user can grasp the driver 112 and push against the driver 112 in order to insert the optoelectronic module product 100 into the host cage. It is noted that during the insertion of the optoelectronic module product 100 into the host cage, the ramps 117, indentations 110, recessed flat portion 118, ramped shoulder portion 119 and flat neck portion 106 of the follower arms 104 and 105 are positioned and oriented to avoid engagement with the surfaces of the host cage.

Once the optoelectronic module product 100 has been fully inserted into the host cage, leaf springs (not shown) of the host cage typically flex inward forward towards the recessed flat portion 118 of each of the follower arms 104 and 105. Also, once in the fully inserted position, the PCBA 150 of the optoelectronic module product 100 is electrically connected to a host connector, the end of the groove 141 on the top shell 140 functions as a hard stop to prevent the optoelectronic module product 100 from being inserted any further into the host cage. Maintaining this fully inserted position of the optoelectronic module product 100 can be achieved using the latching mechanism 113.

Once the optoelectronic module product 100 is fully inserted into the host cage and into the latched position, the example latching mechanism 113 secures the optoelectronic module product 100 within the host cage and abutted against the host connector. Abutment of the optoelectronic module product 100 against the host connector enables tight tolerances and precise alignment with respect to the host connector, which results in precise electrical connections between the optoelectronic module product 100 and the host device.

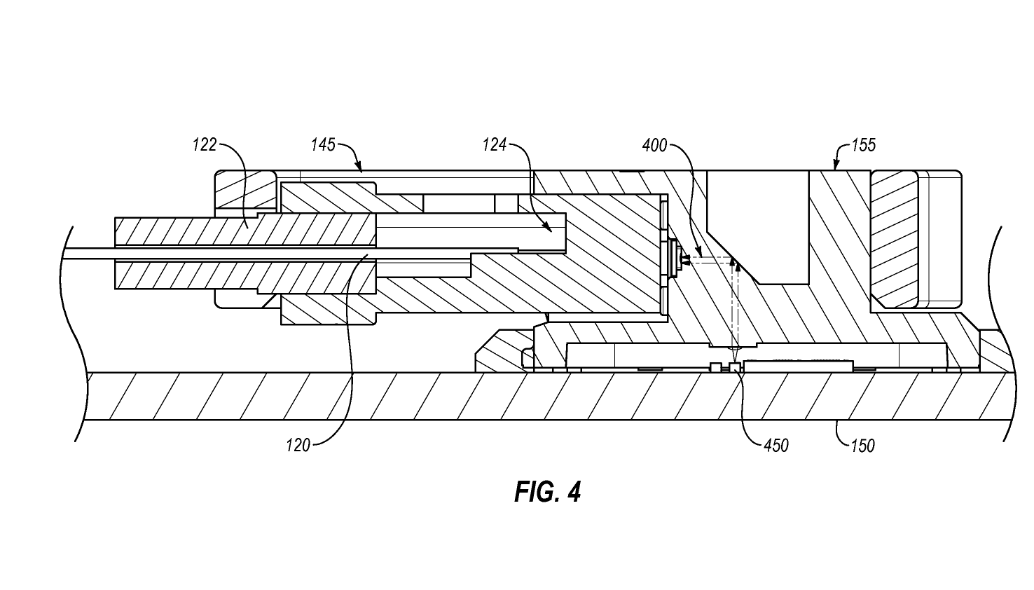

Returning now to FIG. 2, the assembled body 200 includes the bottom shell 130 and top shell 140 coupled together by a pair of screws 170 or other coupling means, the assembled body 200 housing the PCBA 150 with the lens 155 mounted thereon. As was briefly discussed above, one difficulty with the use of the latching mechanism 113 described above is that as the driver 112 is pivoted and pulled, it may result in the active optical cable portion 190 being jostled, which in turn result in the ribbon fibers 120 transferring the force into the inside of the assembled body 200 where the force applied to the ribbon may be transmitted to the ferrule 124 and interfere with the connection between the ferrule 123 and the lens 155 mounted to the PCBA 150. The embodiments described herein prevent the transfer of such force by using an adaptor 410 on the cable boot 107 (described more fully below with respect to FIG. 5) a clip 145, which is formed so as to substantially surround the lens 155 and ferrule 124 and ensure the connection between the lens 155 and the ferrule 124.

FIG. 4 illustrates the process through which light is transmitted from the lens 155 mounted on the PCBA 150 into the ribbon fiber 120. As shown in FIG. 4, active chips 450 bonded on the surface of the PCBA 150 transmit light, which is reflected by the 45 degrees mirror surface of the lens 155 (in this example a right-angle coupling lens) with total internal refection along a light path 400 towards the ribbon fiber 120 housed in the ferrule 124. As may be understood by one of skill in the art, the alignment and the connection between the lens 155 and the ferrule 124 is essential in order to ensure that the light signal is properly transmitted along the ribbon fiber 120.

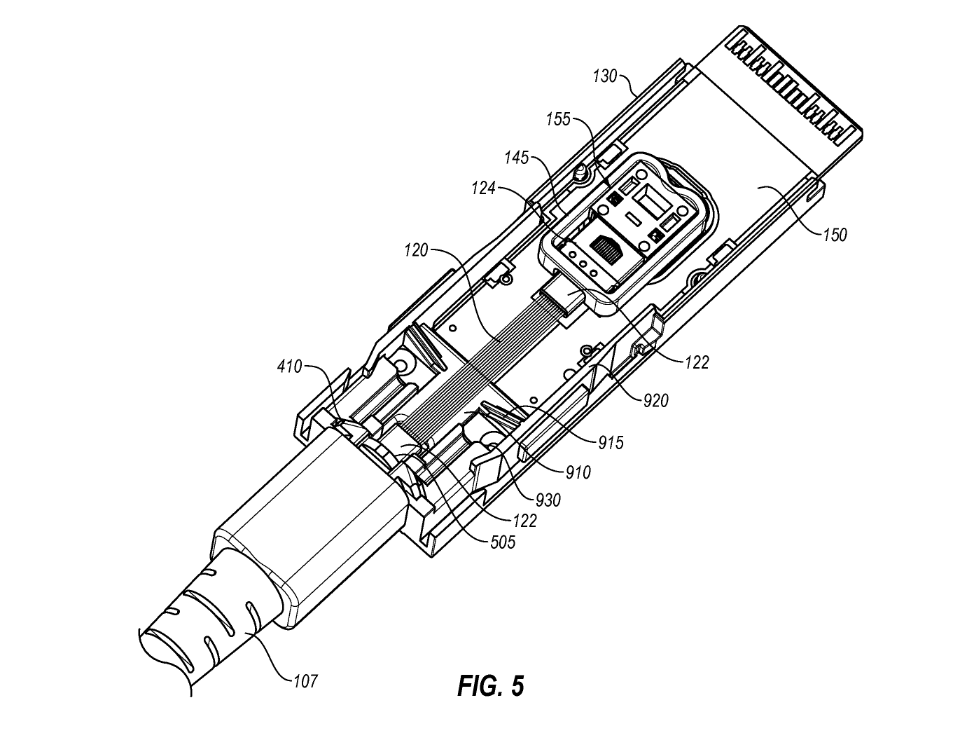

In order to ensure this connection, FIG. 5 illustrates the use of the clip 145. In the view shown in FIG. 5, the top shell 140 has been removed in order to more clearly display the placement of the clip 145 and the adaptor 410 of the cable boot 107. FIG. 6 is an isometric view of the clip 145 alone so as to clearly illustrate the various aspects of the clip 145.

As is shown in FIG. 5, the clip 145 is configured so as to substantially surround the ferrule 124 and the lens 155 so as to hold the ferrule 124 in proper connection with the lens 155. Turning to FIG. 6, the clip 145 has a substantially rectangular shape with the front side 635 having a slot 625 formed therein which is shaped so as to fit over the ferrule boot 122. In this embodiment, the slot 625 includes curved corners 627 although the curved corners 627 may be omitted. The inside surface of the front side 635 has posts 605 formed therein which are formed so as to mate with ferrule holes 126 (as shown in FIG. 2) formed in a surface of the ferrule 124 which faces the ferrule boot 122 when the clip 145 is attached to the active optical cable product 100 during assembly.

As may be understood, the clip 145 may be formed of a variety of materials, including, but not limited to a molded plastic.

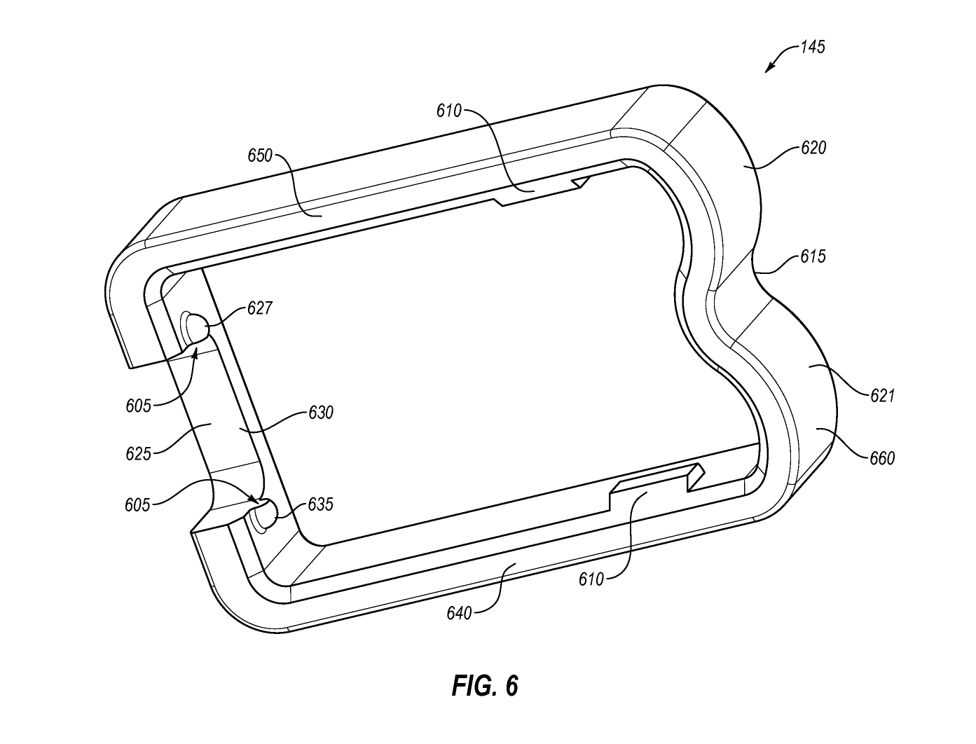

The back surface 660 of the clip 145 of this example comprises three curved surfaces 615, 620 and 621. More specifically, the back surface 660 includes convex surfaces 620 and 621 which bulge outward from the inside of the clip 145 with a concave surface 615 formed therebetween. The concave surface 615, along with protruding ramps 610 formed in each of the side surfaces 640 and 650 of the clip 145 lock or clamps on the lens 155, as is shown in FIGS. 5 and 7. More particularly, the concave surface 615 locks onto a surface of the lens 155 opposite to the surface where the ferrule 124 connects to the lens 155 and the protruding ramps 610 lock on to recesses 156 (shown in FIG. 2) formed in corresponding side surfaces of the lens 155. The concave surface 615 is formed so as to be able to deform when being assembled around the ferrule 124 and lens 155 and once assembled, applies a compressing force which holds the ferrule 124 tightly to the lens 155 so as to secure the connection between the ferrule 124 and the lens and obviate any forces exerted on the interface caused by the ribbon fiber 120 exerting a pulling, twisting or bending motion.

In some embodiments, metal pins 705 (shown in FIG. 2) which extend from an interior of the lens 155 may also extend into the ferrule 124 so as to ensure a proper connection between the lens 155 and the ferrule 124.

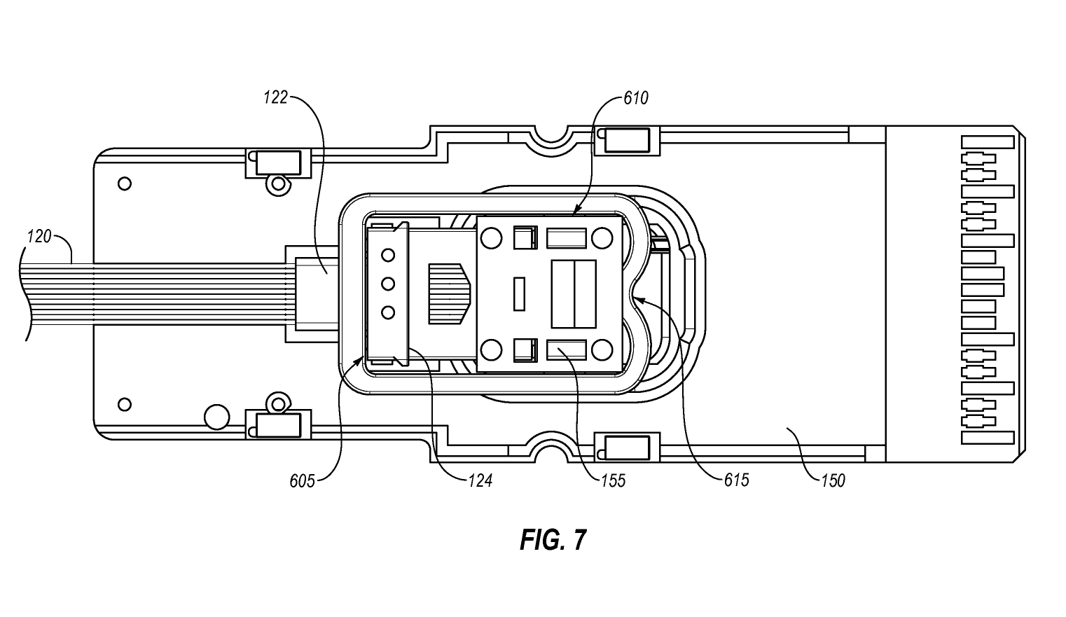

FIGS. 5 and 8 also illustrate another aspect of the embodiments described herein, which provide a more secure connection between the cable boot 107 and the assembled body 200 including the bottom shell 130 and the top shell 140. More specifically, as is shown in FIG. 8, the cable boot 107 includes an adaptor 410 including a pair of ramped prongs 800 and 805 which are configured so as to be housed in a corresponding slots 810 and 820 formed in a front surface of the bottom shell 130. As is illustrated in FIG. 8, when the active optical cable product 100 is being assembled, the ramped prongs 800 and 805 of the adaptor 410 are side into the slots 810 and 820, respectively. As may be understood by one of skill in the art, this aspect of the embodiment causes the ribbon fiber 120 and the cable 101 to be locked in position between the bottom shell 130 and the top shell 140. An intermediary boot 405 is formed on the ribbon fiber 120 as a portion of the cable boot 107 and, when assembled, the intermediary boot 405 is housed in a corresponding housing section 840 of the bottom shell 130.

By locking the ribbon fiber 120 between the cable boot 107 and the ferrule boot 122 by using the adaptor 410 and the clip 145, the ribbon fiber 120 is fixed and the likelihood of any external force applied to the cable 101 being transferred into the interior of the active optical cable product 100 so as to disrupt the connection between the ferrule 124 and the lens 155 is reduced if not completely eliminated.

Further, the clip 145, latching mechanism 113 and the adaptor 410 are all capable of being detached and easily disassembled in the event that maintenance, rework, or testing of the components of the active optical cable product 100 becomes necessary. Hence, the embodiment provides the ability to have a secure connection while providing a solution which can be disassembled if necessary.

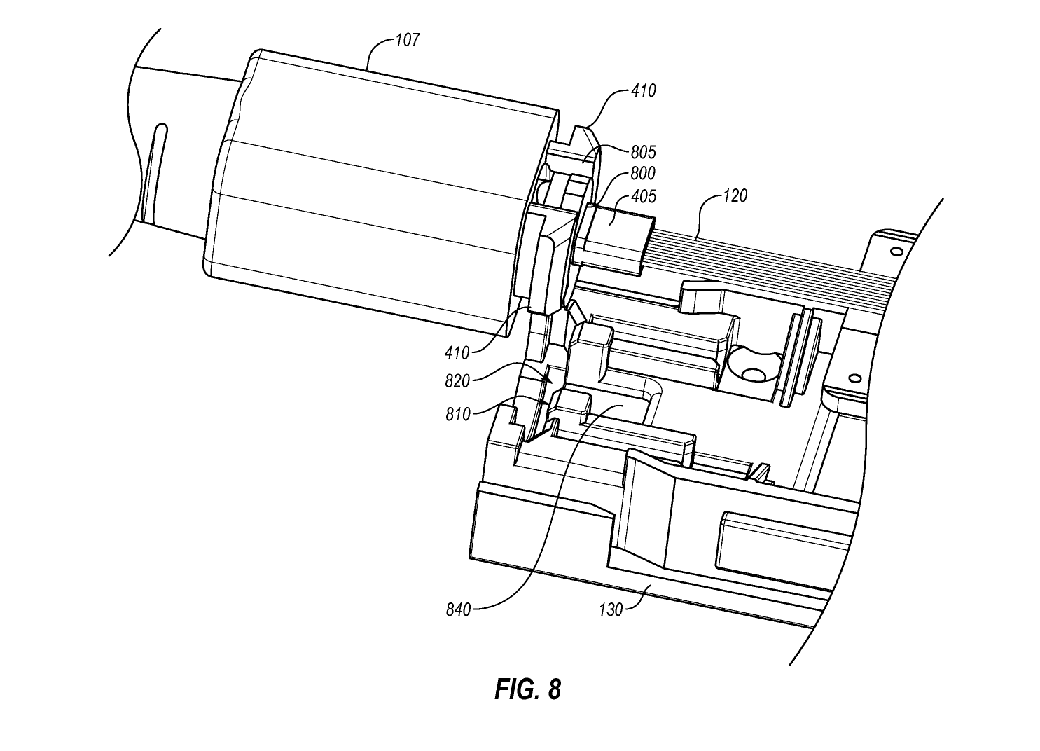

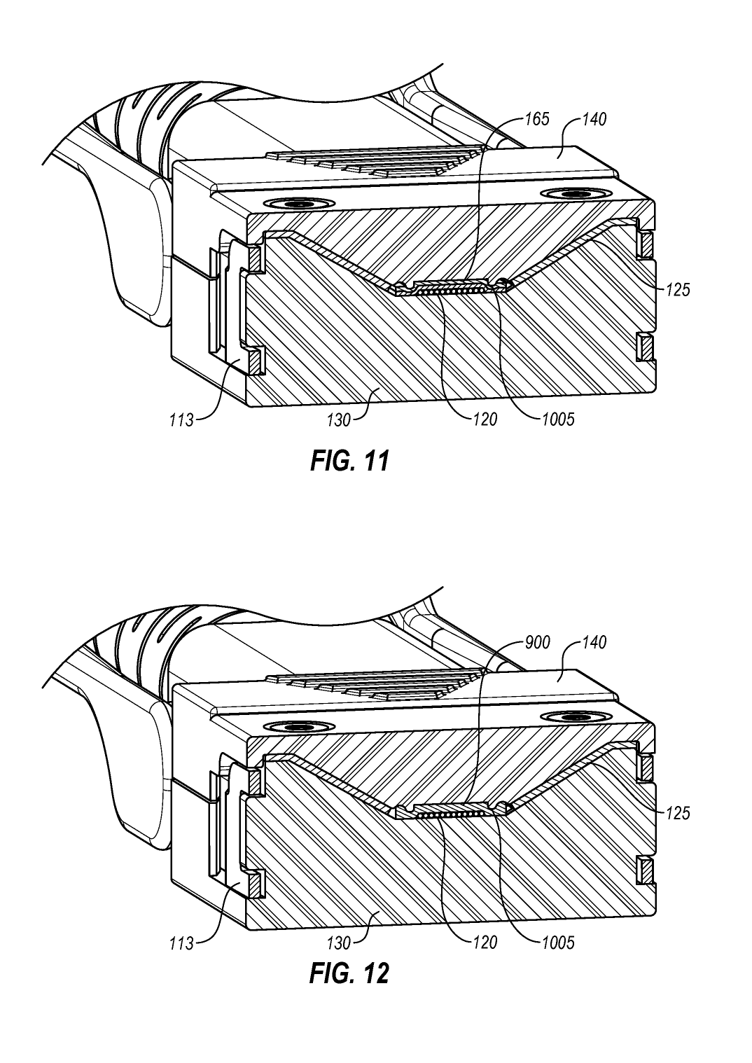

FIGS. 9-12 illustrate another aspect of the embodiment, which includes the ability to prevent electromagnetic waves from leaking out of the interior of the active optical cable product 100. More specifically, the embodiments include an electromagnetic interference (EMI) gasket 165 and EMI paste 125 as shown in FIG. 9. EMI tape 900 is also used as is shown in FIG. 12.

More specifically, as is shown in FIG. 9, which illustrates an assembled active optical cable product 100 with the top shell 130 removed so as to more clearly illustrate the interior components, embodiments described herein may include a EMI gasket 165 which is positioned over the ribbon fiber 120 at a flattened interior portion 910 of the bottom shell 130 (shown more clearly in FIG. 5). As is shown in FIGS. 5 and 9, EMI paste 125 is formed along side walls 920 and interior ribs 915 of the bottom shell 130 so as to prevent EMI leakage from the interior of the active optical cable product 100.

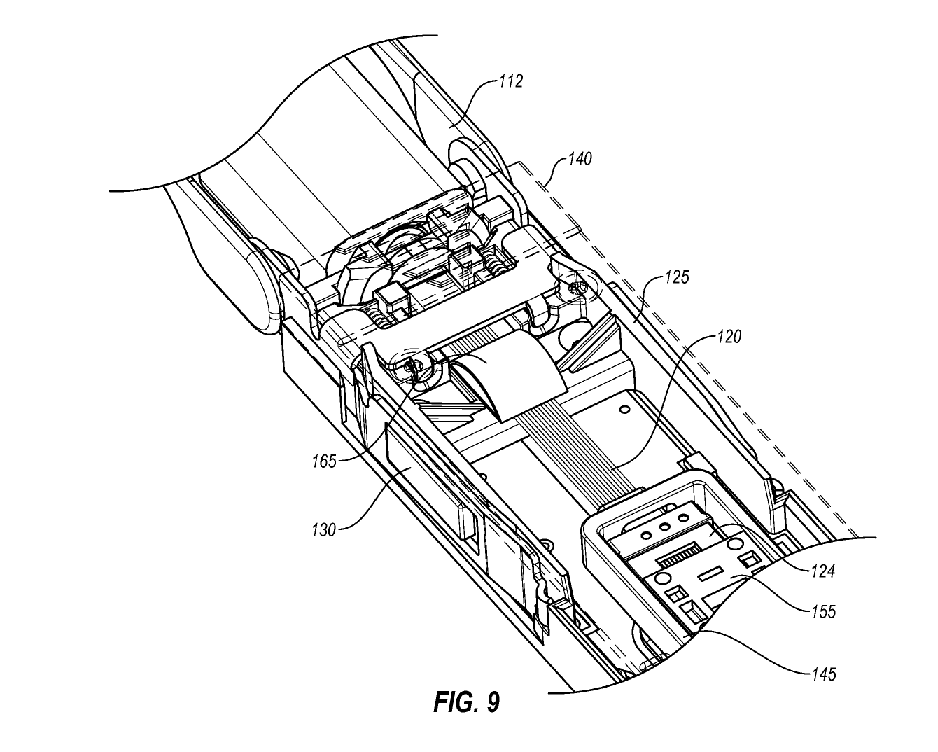

FIG. 10 illustrates the an interior surface 1000 of the top shell 130 so as to illustrate the compressive features of the top shell 130 which compress the EMI gasket 165, EMI paste 125 and the EMI tape 900 as the top shell 130 is joined to the bottom shell 140. The interior surface 1000 includes slots 1015 formed in each side which house the EMI paste 125, ribs 1005 which compress the EMI gasket 165 and EMI tape 900. The interior surface 1000 also includes screw housings 1020 which guide the screws 170 towards the receptacles 930 of the bottom shell 130 shown in FIG. 5 as the top shell 140 and bottom shell 130 are assembled together.

The interior surface 1000 also includes a slot 1010 formed so as to correspond to the slots 810 and 820 of the bottom shell 130 which assist in locking the adaptor 410 of the cable boot 107 into place.

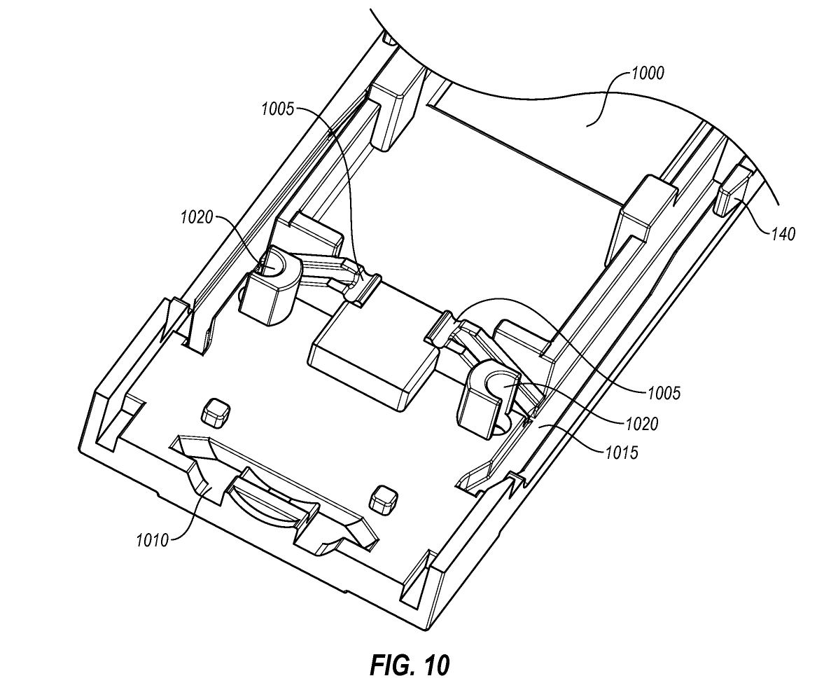

FIGS. 11 and 12 are cross-sectional views which show the EMI gasket 165, EMI paste 125, EMI tape 900 as the EMI gasket 165, EMI paste 125 and the EMI gasket 165 are formed between the top shell 140 and the bottom shell 130 so as to substantially surround and cover the ribbon fiber 120 to further secure the ribbon fiber 120 and prevent the electromagnetic waves generated in the interior of the active optical cable product 100 from being leaked to the exterior of the active optical cable product 100.

As may be understood by one of art, by preventing EMI leakage, the embodiments herein provide a more reliable active optical cable product 100 by containing EMI while providing a simple mechanical structure which secures the ribbon fiber 120 of the active optical cable 190 so as to provide a more reliable connection between the ferrule 124 and the lens 155 of the optoelectronic module 195 and which uses a latching mechanism 113 that provides improved retraction, reduces friction between the latching mechanism 113 and the assembled body 200, and which reduces the overall height of the active optical cable product 100. As is clearly illustrated above, the embodiments described herein provide various benefits not currently taught or suggested by the current art.

The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A pluggable active optical cable product configured to maintain engagement of an optical interface included in an optoelectronic module of the pluggable active optical cable product, the pluggable active optical cable product comprising:
a lens connection section which connects a plurality of optical fibers to the optical interface;
a clip configured to surround the lens connection section and the optical interface so as to apply a compressive force which urges the lens connection section to connect to the optical interface;
a bottom shell which houses the lens connection section, optical interface, and clip; and
a top shell which is configured to be disposed on a surface of the bottom shell when assembled with the bottom shell so as to form an enclosure for the lens connection section, the optical interface, and the clip.

2. The pluggable active optical cable product of claim 1, wherein the lens connection section comprises a MT ferrule and the optical interface comprises a lens which directs an optical signal from an optical transceiver towards the lens connection section.

3. The pluggable active optical cable product of claim 1, the lens connection section further comprising a cable boot section which encloses the plurality of optical fibers and provides a transition between a cable section and the upper shell and bottom shell, the cable boot section including a ferrule and a cable locking mechanism which engages with a portion of at least one of the bottom shell or top shell so as to prevent the ferrule and plurality of optical fibers from moving.

4. The pluggable active optical cable product of claim 3, the cable locking mechanism comprising a pair of ramped prongs which extend from opposing sides of the cable boot and which are housed and engaged with slots formed in the bottom shell when the pluggable active optical cable product is assembled.

5. The pluggable active optical cable product of claim 3, further comprising an electromagnetic interference shielding material disposed in the interior of the top shell and bottom shell between the lens connection section and the cable boot section.

6. The pluggable active optical cable product of claim 5, the electromagnetic interference shielding material comprising an electromagnetic interference shielding gasket disposed on an upper surface of the optical fibers in the interior of the top shell and bottom shell between the lens connection section and the cable boot section.

7. The pluggable active optical cable product of claim 6, the electromagnetic interference shielding material further comprising electromagnetic interference shielding tape disposed on an upper surface of the electromagnetic interference shielding gasket in the interior of the top shell and bottom shell between the lens connection section and the cable boot section and being compressed by a rib formed on an interior surface of the top shell when the top shell is assembled on the bottom shell.

8. The pluggable active optical cable product of claim 7, the electromagnetic interference shielding material further comprising electromagnetic interference shielding paste disposed along each side of the interior of the top shell and bottom shell between the lens connection section and the cable boot section in a direction parallel to a direction that the plurality of optical fibers extend.

9. The pluggable active optical cable product of claim 1, further comprising a latching mechanism, the latching mechanism comprising:
a driver configured to rotate about an axis; and
a follower operably connected to the driver, the follower comprising a pair of follower arms each comprising a ramp facing away from the driver and a shoulder facing toward the driver that is configured to engage with a host device to prevent an electronic device from being removed from the host device,
wherein, the driver is further configured to slide the follower axially toward a front of the electronic device as the driver slide the follower axially away from the front of the electronic device, the driver further configured to position the follower axially farther away from the front of the electronic device when the driver is positioned in the unlatched position than when the driver is positioned in the latched position.

10. An integrated active optical cable and optoelectronic module comprising:
an optical interface which interfaces with a port of a host device;
a lens connection section which connects a plurality of optical fibers to the optical interface;
a clip configured to surround the lens connection section and the optical interface so as to apply a compressive force which urges the lens connection section to connect to the optical interface;
a bottom shell which houses the lens connection section, optical interface, and clip;
a top shell which is configured to be disposed on a surface of the bottom shell when assembled with the bottom shell so as to form an enclosure for the lens connection section, the optical interface, and the clip; and
a latching mechanism configured to rotate about an axis, the latching mechanism comprising a pair of follower arms which engage with the host device when the latching mechanism is in latched position and disengages with the host device when the latching mechanism is in the unlatched position.

11. The integrated active optical cable of claim 10, wherein the lens connection section comprises a MT ferrule and the optical interface comprises a lens which directs an optical signal from an optical transceiver towards the lens connection section.

12. The integrated active optical cable of claim 10, the lens connection section further comprising a cable boot section which encloses the plurality of optical fibers and provides a transition between a cable section and the top shell and bottom shell, the cable boot section including a ferrule and a cable locking mechanism which engages with a portion of at least one of the bottom shell or top shell so as to prevent the ferrule and plurality of optical fibers from moving.

13. The integrated active optical cable of claim 12, the cable locking mechanism comprising a pair of ramped prongs which extend from opposing sides of the cable boot and which are housed and engaged with slots formed in the bottom shell when the pluggable active optical cable product is assembled.

14. The integrated active optical cable of claim 12, further comprising an electromagnetic interference shielding material disposed in the interior of the top shell and bottom shell between the lens connection section and the cable boot section.

15. The integrated active optical cable of claim 14, the electromagnetic interference shielding material comprising an electromagnetic interference shielding gasket disposed on an upper surface of the optical fibers in the interior of the top shell and bottom shell between the lens connection section and the cable boot section.

16. The integrated active optical cable of claim 15, the electromagnetic interference shielding material further comprising electromagnetic interference shielding tape disposed on an upper surface of the electromagnetic interference shielding gasket in the interior of the top shell and bottom shell between the lens connection section and the cable boot section and being compressed by a rib formed on an interior surface of the top shell when the top shell is assembled on the bottom shell.

17. The integrated active optical cable of claim 16, the electromagnetic interference shielding material further comprising electromagnetic interference shielding paste disposed along each side of the interior of the top shell and bottom shell between the lens connection section and the cable boot section in a direction parallel to a direction that the plurality of optical fibers extend.

17. The integrated active optical cable of claim 10, the latching mechanism comprising:
a driver configured to rotate about an axis; and
a follower operably connected to the driver, the follower comprising a pair of follower arms each comprising a ramp facing away from the driver and a shoulder facing toward the driver that is configured to engage with the host device to prevent an electronic device from being removed from the host device,
wherein, the driver is further configured to slide the follower axially toward a front of the electronic device as the driver is sliding from the unlatched position to the latched position and slide the follower axially away from the front of the electronic device as the driver is sliding from the latched position to the unlatched position, the driver further configured to position the follower axially farther away from the front of the electronic device when the driver is positioned in the unlatched position than when the driver is positioned in the latched position.

19. An optoelectronic system comprising the pluggable active optical cable connector of claim 1.

20. An optoelectronic system comprising the integrated active optical cable and optoelectronic module of claim 10.
